(19) United States
(12) Patent Application Publication
(10) Pub. No.: US 2026/0161570 A1
(43) Pub. Date: Jun. 11, 2026

(54) METHOD AND DEVICE FOR VALIDATING SPECULATIVE PHYSICAL ADDRESS

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Seokin Hong, Suwon-si (KR); Junhyeok Park, Suwon-si (KR); Osang Kwon, Suwon-si (KR); Seongwook Kim, Suwon-si (KR); Gwangeun Byeon, Suwon-si (KR); Yongho Lee, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/180,993

(22) Filed: Apr. 16, 2025

(30) Foreign Application Priority Data
Oct. 25, 2024 (KR) 10-2024-0147519
Dec. 11, 2024 (KR) 10-2024-0184027

(51) Int. Cl. G06F 12/1045; G06F 12/0882; G06F 12/1009

(52) U.S. Cl. CPC G06F 12/1045; G06F 12/0882; G06F 12/1009

(57) ABSTRACT

An electronic device includes a processing unit, a memory management unit, and a memory, where the memory management unit is configured to, based on a memory access request for accessing a target virtual address received from the processing unit, translate the target virtual address into a speculative physical address based on an offset table including an address translation offset per program counter, and the processing unit is configured to obtain temporary data stored in a first memory area that corresponds to the speculative physical address, where the first memory area is in the memory, validate the speculative physical address by comparing the target virtual address with a validation virtual address included in the temporary data stored in the first memory area that corresponds to the speculative physical address, based on a successful validation of the speculative physical address, determine that the temporary data is valid data.

### CROSS-REFERENCE TO RELATED APPLICATION

This application is based on and claims priority to Korean Patent Application No. 10-2024-0147519, filed on Oct. 25, 2024, in the Korean Intellectual Property Office, and Korean Patent Application No. 10-2024-0184027, filed on Dec. 11, 2024, in the Korean Intellectual Property Office, the disclosures of which are incorporated by reference herein in their entireties.

### BACKGROUND

### 1. Field

The disclosure relates to validation of a speculative physical address.

### 2. Description of Related Art

Address translation is the process of translating a virtual address into a physical address in a computer system and is essential technology in modern computing environments. An operating system (OS) may provide an independent memory space for each application through address translation to support memory protection and efficient resource management.

Address translation may be performed using a page table. A virtual address may be divided into a virtual page number (VPN) and a page offset, and the VPN may be mapped to a corresponding physical page number (PPN) through a page table. The speed of address translation may be improved by utilizing a cache such as a translation lookaside buffer (TLB).

Address translation is widely used in various hardware devices such as a central processing unit (CPU) and a graphics processing unit (GPU) and plays an important role in enhancing multitasking, memory sharing, and security through memory virtualization.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of the disclosure, an electronic device may include a processing unit, a memory management unit, and a memory, where the memory management unit is configured to, based on a memory access request for accessing a target virtual address received from the processing unit, translate the target virtual address into a speculative physical address based on an offset table including an address translation offset per program counter, and the processing unit is configured to obtain temporary data stored in a first memory area that corresponds to the speculative physical address, where the first memory area is in the memory, validate the speculative physical address by comparing the target virtual address with a validation virtual address included in the temporary data stored in the first memory area that corresponds to the speculative physical address, based on a successful validation of the speculative physical address, determine that the temporary data is valid data.

The processing unit may include a level 1 (L1 ) cache, and the L1 cache may be configured to obtain the target virtual address and compressed data stored in the first memory area, decompress the compressed data into the temporary data, obtain the validation virtual address from the compressed data, and compare, as an in-cache operation, the validation virtual address to the target virtual address.

The memory management unit may include an L1 translation lookaside buffer (TLB) (L1 TLB), and the L1 TLB may be configured to obtain the memory access request prior to the memory management unit translating the target virtual address into the speculative physical address, based on the memory access request, look up, in an internal memory of the L1 TLB, a page table entry corresponding to the target virtual address, based on the internal memory of the L1 TLB including the page table entry corresponding to the target virtual address, obtain a valid physical address based on the page table entry, and based on the internal memory of the L1 TLB not including the page table entry corresponding to the target virtual address, transmit, to the memory management unit, a request for obtaining the speculative physical address using the offset table.

The memory management unit may be further configured to determine, from among candidate address translation offsets included in the offset table, a target address translation offset corresponding to a target program counter of the memory access request, and obtain the speculative physical address based on a result of applying the target address translation offset to the target virtual address.

The memory management unit may be further configured to determine, from among candidate offset table entries included in the offset table, an offset table entry corresponding to the target program counter, based on a confidence level (CL) identifier indicating a CL for the target address translation offset in the determined offset table entry, determine whether to use the target address translation offset, and based on determining to use the target address translation offset, obtain the speculative physical address using the target address translation offset.

The memory management unit may be further configured to obtain a valid physical address corresponding to the target virtual address using a page table in parallel with at least one of an acquisition process of the speculative physical address and a validation process of the speculative physical address.

The processing unit may be further configured to, based on failure to validate the speculative physical address, obtain valid data from a second memory area corresponding to the valid physical address.

The memory management unit may be further configured to, based on the successful validation of the speculative physical address, determine to not proceed with an operation of obtaining the valid physical address or determine to stop proceeding with the operation of obtaining the valid physical address if the operation of obtaining the valid physical address is proceeding when the speculative physical address is successfully validated.

The processing unit may be further configured to, based on the temporary data including the validation virtual address, validate the speculative physical address using the validation virtual address, based on the temporary data not including the validation virtual address, determine that it is not possible to validate the speculative physical address based on the validation virtual address.

The memory may include a device memory, the electronic device may include a memory controller configured to operate with the device memory, and the memory controller may be configured to receive, from a main processing device, page information including a data page and a virtual page number (VPN) of the data page, compress the data page, and store the compressed data page and the page information in a third memory area of the device memory that is allocated to the data page.

The data page may include a data sector corresponding to an access unit of the processing unit and the memory controller may be further configured to store the compressed data sector and the page information in a fourth memory area in the device memory allocated to the data sector.

The data page may include a first data sector and a second data sector, and the memory controller may be further configured to store, together with the page information, a compressed first data sector obtained by compressing the first data sector, and store, together with the page information, a compressed second data sector obtained by compressing the second data sector.

The memory management unit may be further configured to, based on the successful validation of the speculative physical address, increase a CL of an offset table entry corresponding to a target program counter of the memory access request in the offset table.

The memory management unit may be further configured to, based on failure to validate the speculative physical address, change an offset table entry corresponding to a target program counter of the memory access request in the offset table, based on an offset between the target virtual address and a valid physical address.

The memory management unit may include a L1 TLB and the L1 TLB may be configured to, based on the successful validation of the speculative physical address, store a page table entry including the speculative physical address and the target virtual address in an internal memory of the L1 TLB.

According to an aspect of the disclosure, a method performed by an electronic device that includes a processing unit, a memory management unit, and a memory, may include translating, by the memory management unit and based on a memory access request for a target virtual address received from the processing unit, the target virtual address into a speculative physical address based on an offset table including an address translation offset per program counter, obtaining, by the processing unit, temporary data stored in a first memory area that corresponds to the speculative physical address, where the first memory area is in the memory, validating, by the processing unit, the speculative physical address by comparing the target virtual address with a validation virtual address included in the temporary data stored in the first memory area that corresponds to the speculative physical address, and based on a successful validation of the speculative physical address, determine that the temporary data is valid data.

The processing unit may include an L1 cache, and the validating of the speculative physical address may include obtaining, by the L1 cache, compressed data stored in the target virtual address and the first memory area, decompressing, by the L1 cache, the compressed data into the temporary data, obtaining the validation virtual address from the compressed data, and comparing, by the L1 cache, as an in-cache operation, the validation virtual address with the target virtual address.

The memory management unit may include a L1 TLB, and the method may include obtaining, by the L1 TLB, the memory access request prior to the memory management unit translating the target virtual address into the speculative physical address, looking up, by the L1 TLB, based on the memory access request, a page table entry corresponding to the target virtual address in an internal memory of the L1 TLB, obtaining, by the L1 TLB, based on the internal memory of the L1 TLB including the page table entry corresponding to the target virtual address, a valid physical address based on the page table entry, and based on the internal memory of the L1 TLB not including the page table entry corresponding to the target virtual address, transmitting, by the L1 TLB, to the memory management unit, a request for obtaining the speculative physical address using the offset table.

The translating of the target virtual address into the speculative physical address may include determining, by the memory management unit, from among candidate address translation offsets included in the offset table, a target address translation offset corresponding to a target program counter of the memory access request, and obtaining, by the memory management unit, the speculative physical address based on a result of applying the target address translation offset to the target virtual address.

The translating of the target virtual address into the speculative physical address may include determining, by the memory management unit, from among candidate offset table entries included in the offset table, an offset table entry corresponding to the target program counter, based on a CL indicator indicating a CL for the target address translation offset of the determined offset table entry, determining, by the memory management unit, whether to use the target address translation offset, and based on determining to use the target address translation offset, obtaining, by the memory management unit, the speculative physical address based on the target address translation offset.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating an example of a heterogeneous computing system according to one or more embodiments;

FIG. 2 is a flowchart illustrating an example of a method in which an electronic device performs address translation, according to one or more embodiments;

FIG. 3 is a flowchart illustrating an example of an operation in which an electronic device obtains a speculative physical address, according to one or more embodiments;

FIG. 4 is a diagram illustrating an example of an operation of storing data in a device memory of an electronic device, according to one or more embodiments;

FIG. 5 is a diagram illustrating an example of an operation of validating a speculative physical address, according to one or more embodiments; and

FIG. 6 is a diagram illustrating a time difference between a case in which an electronic device uses a speculative physical address and a case in which the electronic device uses a valid physical address, according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

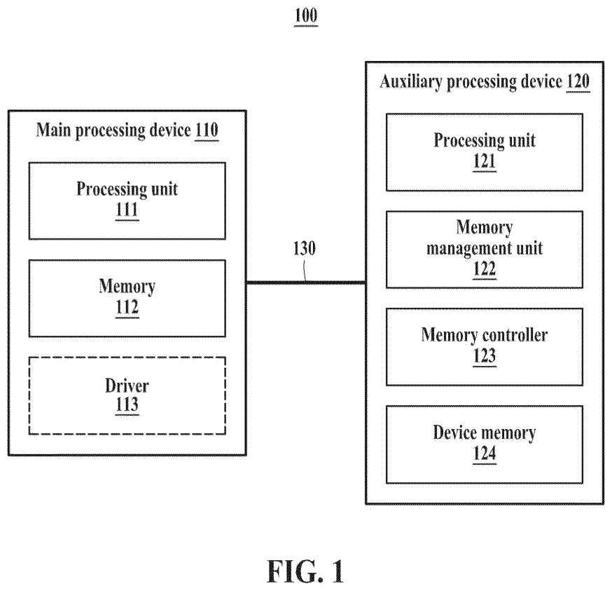

FIG. 1 is a diagram illustrating an example of a heterogeneous computing system according to one or more embodiments.

According to one or more embodiments, a heterogeneous computing system 100 may include a main processing device 110, an auxiliary processing device 120, and an interconnect 130.

The main processing device 110 may manage various operations including central control, a general operation, logical control, and/or scheduling of the heterogeneous computing system 100. The main processing device 110 may be optimized for serial processing and may effectively perform complex control flow and/or multi-thread management. The main processing device 110 may manage resources of the overall heterogeneous computing system 100, including memory management, input/output control, and the like. For example, the main processing device 110 may perform the role of allocating a task (e.g., execution of an application) to the auxiliary processing device 120. For example, the main processing device 110 may include a central processing unit (CPU).

The auxiliary processing device 120 may perform a large number of operations at high speed in cooperation with the main processing device 110. The auxiliary processing device 120 may be optimized for performing a graphic operation and/or a data-intensive calculation that require parallel processing. For example, the auxiliary processing device 120 may reduce the number of operations of the main processing device 110 by performing large-scale parallel operations such as vector and matrix operations. According to one or more embodiments, the auxiliary processing device 120 may outperform the main processing device 110 in a specialized task such as graphic rendering and/or artificial intelligence (AI) model inference and learning.

The interconnect 130 may support data transmission between the main processing device 110 and the auxiliary processing device 120. According to one or more embodiments, the interconnect 130 may include a peripheral component interconnect express (PCIe) interface and/or an NVLink interface. The PCIe interface is a type of general-purpose high-speed serial interface that may be used to transmit data between the main processing device 110 and the auxiliary processing device 120 with relatively high bandwidth and low latency. The NVLink interface is a type of interface designed for communication between the auxiliary processing device 120 with high performance and the main processing device 110 and may provide higher bandwidth than the PCIe interface. The NVLink interface may maximize performance for an operation-intensive task. The NVLink interface may support more efficient data access between the main processing device 110 and the auxiliary processing device 120 while maintaining a high data transmission rate between the main processing device 110 and the auxiliary processing device 120. In particular, the NVLink interface may be optimized for memory sharing and operation-intensive tasks and may contribute to reducing data transmission bottlenecks between the main processing device 110 and the auxiliary processing device 120.

In one or more embodiments, the main processing device 110 may be referred to as a CPU, and the auxiliary processing device 120 may be referred to as a graphics processing unit (GPU). The main processing device 110 may be referred to as a host device, and the auxiliary processing device 120 may be referred to as a device or an electronic device. The main processing device 110 may be referred to as a processing unit, and the auxiliary processing device 120 may be referred to as an accelerator (or a hardware accelerator). The main processing device 110 may be referred to as a main processing unit, and the auxiliary processing device 120 may be referred to as an auxiliary processing unit.

According to one or more embodiments, the main processing device 110 may include a processing unit 111, a memory 112, and a driver 113.

The processing unit 111 (e.g., a core) may perform a basic operation of the heterogeneous computing system 100. The processing unit 111 may include processing circuitry. The processing unit 111 may efficiently manage a general operation of the heterogeneous computing system 100 as well as interaction with the auxiliary processing device 120.

The memory 112 may include a memory for temporarily storing and accessing task data of the heterogeneous computing system 100. The memory 112 may quickly provide data required for the main processing device 110 to perform a task and may also perform a role such as data buffering in data exchange with the auxiliary processing device 120.

The driver 113 may include a GPU driver 113 that controls an operation of the auxiliary processing device 120. The driver 113 may be a software component that manages command transmission, memory allocation, data exchange, and the like between the main processing device 110 and the auxiliary processing device 120. The driver 113 may support the main processing device 110 to effectively utilize a resource of the auxiliary processing device 120. For example, the driver 113 may manage a state of the auxiliary processing device 120 and perform the role of transmitting, to the auxiliary processing device 120, a task request for the auxiliary processing device 120 generated by the main processing device 110.

According to one or more embodiments, the auxiliary processing device 120 may include a processing unit 121, a memory controller 123, a memory management unit 122, and a device memory 124.

The processing unit 121 may include one or more streaming multiprocessors (SMs). Each SM may include a plurality of operation cores and perform a task requiring parallel processing at high speed. The processing unit 121 may include processing circuitry. The processing unit 121 may generate a memory access request (e.g., a memory load request and a memory store request) for a virtual address. The processing unit 121 may transmit, to the memory management unit 122, an address translation request including a virtual address.

The memory management unit 122 may support efficient data access by managing an internal memory space (e.g., the device memory 124) and an external memory space of the auxiliary processing device 120. The memory management unit 122 may perform address translation to translate a virtual address into a physical address. The memory management unit 122 may include a level 1 (L1) translation lookaside buffer (TLB) (L1 TLB) and/or a level 2 (L2) TLB. As described below, the memory management unit 122 may perform speculation-based address translation for efficiency. In one or more embodiments, the memory management unit 122 may also be referred to as a GPU memory management unit (GMMU). The memory management unit 122 may return a physical address to the processing unit 121.

The processing unit 121 may obtain data stored in a memory area corresponding to the physical address. The processing unit 121 may further include an L1 cache. The processing unit 121 may check whether data corresponding to the physical address is stored in the internal memory of the L1 cache (e.g., an L1 cache memory). The L1 cache may include an internal memory of the L1 cache (also referred to as an L1 cache memory in one or more embodiments) and an L1 cache controller (e.g., control circuitry). In one or more embodiments, an operation by the L1 cache may be substantially referred to as an operation by the L1 cache controller. The processing unit 121 may obtain data stored in the internal memory of the L1 cache as a response to a memory access request when data corresponding to the physical address is stored (e.g., L1 cache hit) in the internal memory of the L1 cache. The processing unit 121 may transmit the physical address to the memory controller 123 when data corresponding to the physical address is not stored (e.g., L1 cache miss) in the internal memory of the L1 cache.

However, when the processing unit 121 has an L1 cache miss, embodiments are not limited to transmitting a memory access request to the memory controller 123. According to one or more embodiments, the auxiliary processing device 120 may further include an L2 cache. The L2 cache may include an internal memory (also referred to as an L2 cache memory in one or more embodiments) and an L2 cache controller (e.g., control circuitry). In one or more embodiments, an operation by the L2 cache may be substantially interpreted as an operation by the L2 cache controller.

The L1 cache (or the processing unit 121) may transmit the physical address to the L2 cache in case of an L1 cache miss. When data corresponding to the physical address is stored (e.g., L2 cache hit) in the internal memory (e.g., the L2 cache memory) of the L2 cache, the L2 cache may transmit the data to the processing unit 121. The processing unit may obtain the data received from the L2 cache as a response to the memory access request. The processing unit 121 may transmit the received data to the L1 cache. When the data corresponding to the physical address is not stored in the internal memory (e.g., the L2 cache memory) of the L2 cache, the L2 cache may transmit the physical address to the memory controller 123.

The memory controller 123 may receive the physical address from the L2 cache. The memory controller 123 may support a memory request for the device memory 124. The memory controller 123 may obtain (e.g., load) data stored in a memory area by accessing a memory area corresponding to the physical address in the device memory 124. The memory controller 123 may transmit the obtained data to the processing unit 121. The processing unit 121 may transmit the received data to the L1 cache.

The device memory 124 may include a memory space for storing and accessing data required for an operation performed by the auxiliary processing device 120. The device memory 124 may be designed to enable high-speed data access. For example, the device memory 124 may include a high-performance graphics double data rate (GDDR) memory or high bandwidth memory (HBM). The device memory 124 may store data required during an operation process and an operation result. The device memory 124 may include, for example, dynamic random access memory (DRAM).

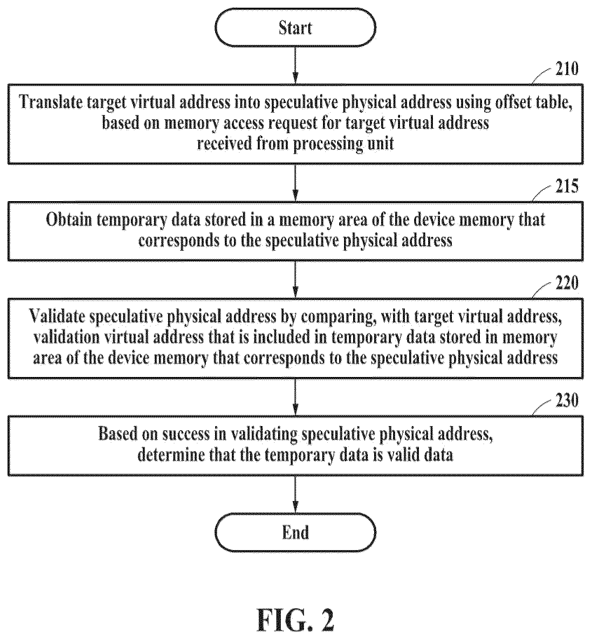

FIG. 2 is a diagram illustrating an example of a method in which an electronic device performs address conversion, according to one or more embodiments.

According to one or more embodiments, an electronic device (e.g., the auxiliary processing device 120 of FIG. 1) may include a processing unit (e.g., the processing unit 121 of FIG. 1), a memory management unit (e.g., the memory management unit 122 of FIG. 1), and a memory. The memory may include a device memory (e.g., the device memory 124 of FIG. 1). However, embodiments are not limited thereto, and the memory may further include a cache memory (e.g., an L1 cache memory, an L2 cache memory, an L1 TLB memory, and an L2 TLB memory).

According to one or more embodiments, the processing unit may generate a memory access request for a target virtual address. The memory access request for the target virtual address may be a memory request requesting to load (or read) data corresponding to the target virtual address. The processing unit may transmit the memory access request for the target virtual address to the memory management unit. The memory management unit may receive the memory access request for the target virtual address from the processing unit.

According to one or more embodiments, a virtual address (e.g., the target virtual address) may include a virtual page number (VPN) and a page offset. The VPN may include the virtual address (or a virtual base address) of a data page that includes a memory area corresponding to the virtual address. The page offset may be the difference between a base address (e.g., a physical base address) of the memory area corresponding to the virtual address in the data page and a base address (e.g., a physical base address) of the data page.

The memory management unit may check an L1 TLB before obtaining a speculative physical address.

According to one or more embodiments, the memory management unit may include the L1 TLB. The L1 TLB may include an internal memory (also referred to as an L1 TLB memory in one or more embodiments) and an L1 TLB controller (e.g., an L1 TLB controller including control circuitry). In one or more embodiments, an operation of the L1 TLB may be substantially referred to as an operation of the L1 TLB controller. The memory management unit may transmit the memory access request for the virtual address to the L1 TLB. The L1 TLB may obtain the memory access request before the memory management unit translates the target virtual address into the speculative physical address. Based on the memory access request, the L1 TLB may look up a page table entry corresponding to the target virtual address in the internal memory of the L1 TLB.

The L1 TLB may obtain, based on the internal memory of the L1 TLB storing the page table entry corresponding to the virtual address (e.g., L1 TLB hit), a valid physical address based on the page table entry. Based on the internal memory of the L1 TLB storing the page table entry corresponding to the virtual address (e.g., L1 TLB hit), acquisition of a speculative physical address by the memory management unit and validation of a speculative physical address by the processing unit may be skipped (e.g., not performed). The valid physical address may be a physical address corresponding to a valid target virtual address without the need for validation. The L1 TLB may transmit the valid physical address to the processing unit. The processing unit may obtain, as a response to the memory access request, data stored in a memory area corresponding to the valid physical address.

Based on the internal memory of the L1 TLB not storing the page table entry corresponding to the target virtual address, the L1 TLB may transmit, to the memory management unit, a request for obtaining a speculative physical address using an offset table. The electronic device may further include a miss status handling register (MSHR) corresponding to the L1 cache. The L1 cache may store at least a portion of the target virtual address (e.g., a VPN) in the MSHR corresponding to the L1 cache. As described below, at least a portion of the target virtual address stored in the MSHR corresponding to the L1 cache may be compared with a validation virtual address.

In operation 210, based on the memory access request for the target virtual address, the memory management unit may translate the target virtual address into a speculative physical address using an offset table.

According to one or more embodiments, the offset table may include an address translation offset per program counter. For example, the offset table may include a plurality of offset table entries, each of which may correspond to a program counter. An offset table including an address translation offset (e.g., a virtual address to physical address (V2P) offset) per program counter may be stored. The program counter may include an instruction identifier in which each memory access request is generated. The address translation offset may be the difference between a virtual address and a physical address. In one or more embodiments, the offset table may also be referred to as a mapping offset detection table (MODT). In one or more embodiments, the program counter may also be referred to as an instruction pointer. Obtaining the speculative physical address is described below in more detail.

As described below, the speculative physical address based on the offset table may be the same as the physical address corresponding to the target virtual address (e.g., when validation of the speculative physical address is successful) or may be different from the physical address corresponding to the target virtual address (e.g., when validation of the speculative physical address fails to pass).

The memory management unit may transmit (e.g., return) the speculative physical address to the processing unit. The processing unit may validate the speculative physical address received from the memory management unit.

In operation 215, the processing unit may obtain temporary data stored in a memory area of the device memory that corresponds to the speculative physical address. The processing unit may further include an L1 cache.

The processing unit may transmit the speculative physical address to the memory controller (e.g., the memory controller 123 of FIG. 1) and receive the temporary data from the memory controller.

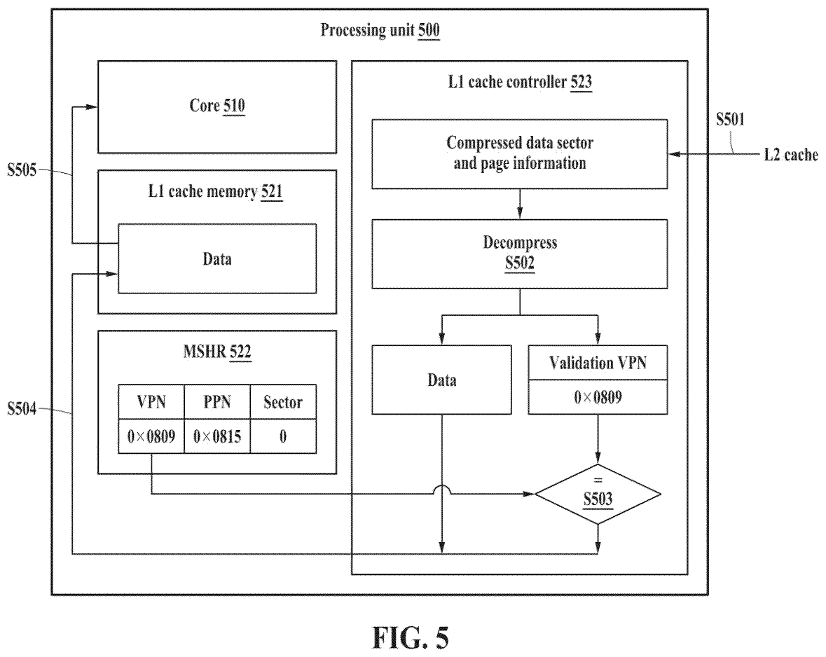

In operation 220, the processing unit may validate the speculative physical address by comparing, with the target virtual address, a validation virtual address that is included in temporary data stored in a memory area of the device memory that corresponds to the speculative physical address. The temporary data that is stored in the memory area of the device memory that corresponds to the speculative physical address may also be obtained by the processing unit as described above. The validation virtual address may include a validation VPN. The processing unit may validate the speculative physical address with an in-cache operation. Successful validation of the speculative physical address may indicate that the speculative physical address is valid for the target virtual address. Failure to validate the speculative physical address may indicate that the speculative physical address is invalid for the target virtual address. Validation of the speculative physical address is described below in more detail with reference to FIG. 5.

In operation 230, based on success in validating the speculative physical address, the processing unit may determine that the temporary data is valid data, based on success in validating the speculative physical address. Valid data may be valid data for the memory access request.

For example, the processing unit may store temporary data in the internal memory of the L1 cache (e.g., L1 cache memory), based on success in validating the speculative physical address.

According to one or more embodiments, the memory management unit may further include the L1 TLB. Based on success in validating the speculative physical address, the L1 TLB may store a page table entry including the speculative physical address and the target virtual address in the internal memory of the L1 TLB. The page table entry may include the speculative physical address, the target virtual address, and page information (e.g., permissions). The page information is information about a data page corresponding to a physical address and a virtual address and may include a dirty bit, a valid bit, and/or a read-only bit.

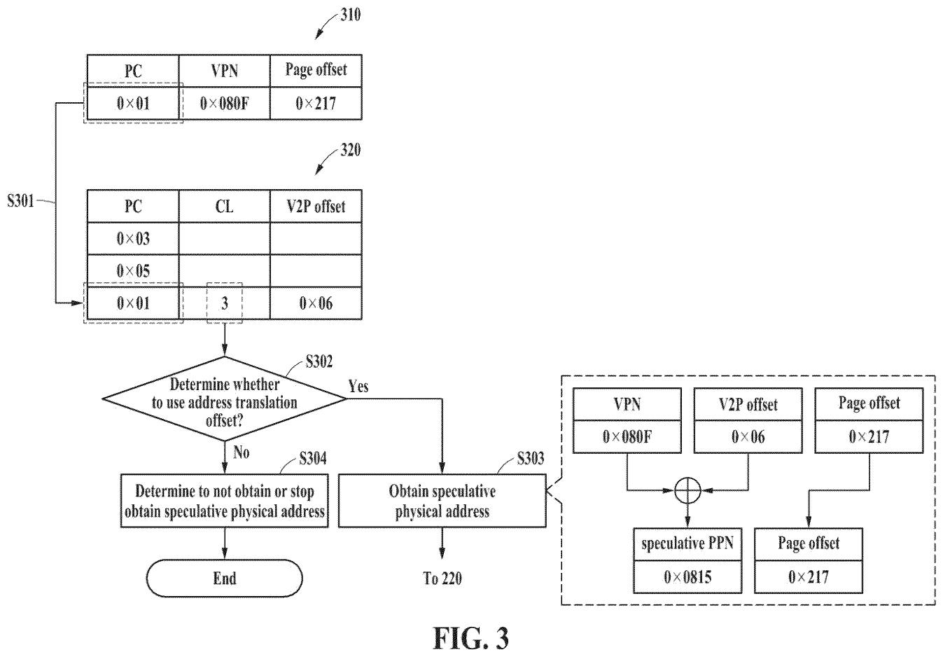

FIG. 3 is a diagram illustrating an example of an operation in which an electronic device obtains a speculative physical address, according to one or more embodiments.

According to one or more embodiments, a memory management unit (e.g., the memory management unit 122 of FIG. 1) may obtain a memory access request 310 for a virtual address. The memory access request 310 may include a program counter (shown as PC in FIG. 3) and a target virtual address. The program counter may be a program counter for an instruction that generates the memory access request 310. The target virtual address may include a VPN and a page offset (the page offset in FIG. 3).

According to one or more embodiments, the memory management unit may determine, from among candidate address translation offsets included in an offset table 320, a target address translation offset corresponding to a target program counter of the memory access request 310. Each candidate address translation offset included in the offset table 320 may correspond to a program counter. The memory management unit may obtain a speculative physical address based on the result of applying the target address translation offset to the target virtual address.

In operation S301, the memory management unit may determine, from among the candidate offset table entries included in the offset table 320, an offset table entry corresponding to the target program counter. The offset table 320 may include a plurality of candidate offset table entries. Each candidate offset table entry may include a program counter to which the candidate offset table entry corresponds, a confidence level (CL) indicator (e.g., count and state count), and a candidate address translation offset (V2P Offset). The memory management unit may determine, as the offset table entry, a candidate offset table entry corresponding to the program counter (e.g., 0x01) of the memory access request 310.

According to one or more embodiments, the CL indicator may be an indicator indicating a CL for the offset table entry (e.g., an address translation offset). For example, the CL indicator may include the number of times validation of a speculative physical address based on the offset table entry is successful.

An offset table may not include an offset table entry corresponding to the target program counter, or an address translation offset may not exist in the offset table entry corresponding to the target program counter. In this case, the memory management unit may determine not to use the offset table and perform an operation of obtaining a valid physical address using a page table. After a valid physical address corresponding to the target virtual address is obtained, the memory management unit may add, to the offset table, an offset table entry and/or an address translation offset of the offset table entry based on the valid physical address.

In operation S302, the memory management unit may determine whether to use the target address translation offset based on a CL indicator indicating the CL of the target address translation offset in the determined offset table entry. The memory management unit may determine whether to use the target address translation offset based on the result of comparing a CL with a threshold CL. For example, the memory management unit may determine to use the target address translation offset based on the CL being greater than the threshold CL. The memory management unit may determine not to use the target address translation offset based on the CL being less than or equal to the threshold CL.

In operation S303, the memory management unit may obtain a speculative physical address using the target address translation offset, based on determining to use the target address translation offset in operation S302. The memory management unit may obtain a speculative physical page number (PPN) by accumulating a VPN and a target address translation offset of the memory access request 310. The memory management unit may obtain, as the speculative physical address, the speculative PPN and the page offset.

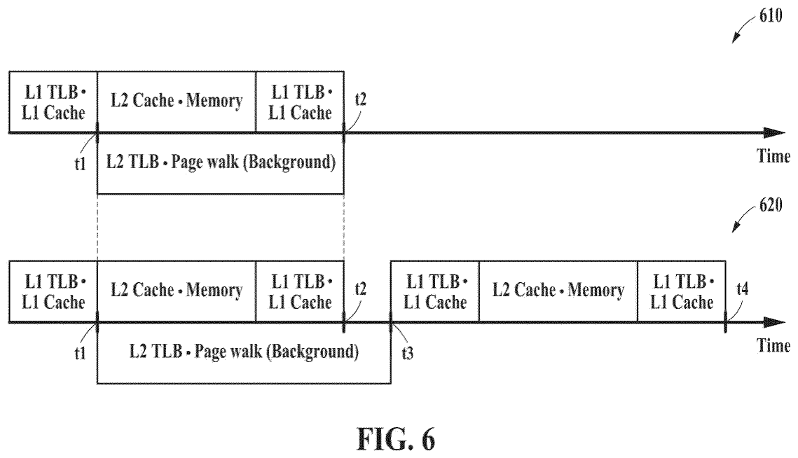

In operation S304, based on determining not to use the target address translation offset in operation S302, the memory management unit may determine to not obtain or stop obtaining the speculative physical address (e.g., skip at least a portion of an operation of obtaining the speculative physical address). As described below with reference to FIG. 6, the memory management unit may obtain a valid physical address in parallel with acquisition of the speculative physical address. The memory management unit may transmit the valid physical address to the processing unit.

According to one or more embodiments, the memory management unit may update the offset table 320 based on the result of validating the speculative physical address. For example, based on success in validating the speculative physical address, the memory management unit may increase the CL of the target offset table entry corresponding to the target program counter of the memory access request 310 in the offset table 320. For example, the memory management unit may replace the target offset table entry based on failure to validate the speculative physical address. Based on failure to validate the speculative physical address, the memory management unit may change, using an offset between the target virtual address and the valid physical address, the target offset table entry corresponding to the target program counter of the memory access request 310 in the offset table 320.

According to one or more embodiments, the memory management unit may update the offset table 320 even when it is determined that the address translation offset is not determined. For example, the memory management unit may determine the offset between the target virtual address and the valid physical address. When the address translation offset of the target offset table entry is the same as the offset between the target virtual address and the valid physical address in the offset table 320, the memory management unit may increase a CL. When the address translation offset of the target offset table entry is different from the offset between the target virtual address and the valid physical address in the offset table 320, the memory management unit may change the address translation offset of the target offset table entry to the offset between the target virtual address and the valid physical address and set a CL to an initial value (e.g., 1).

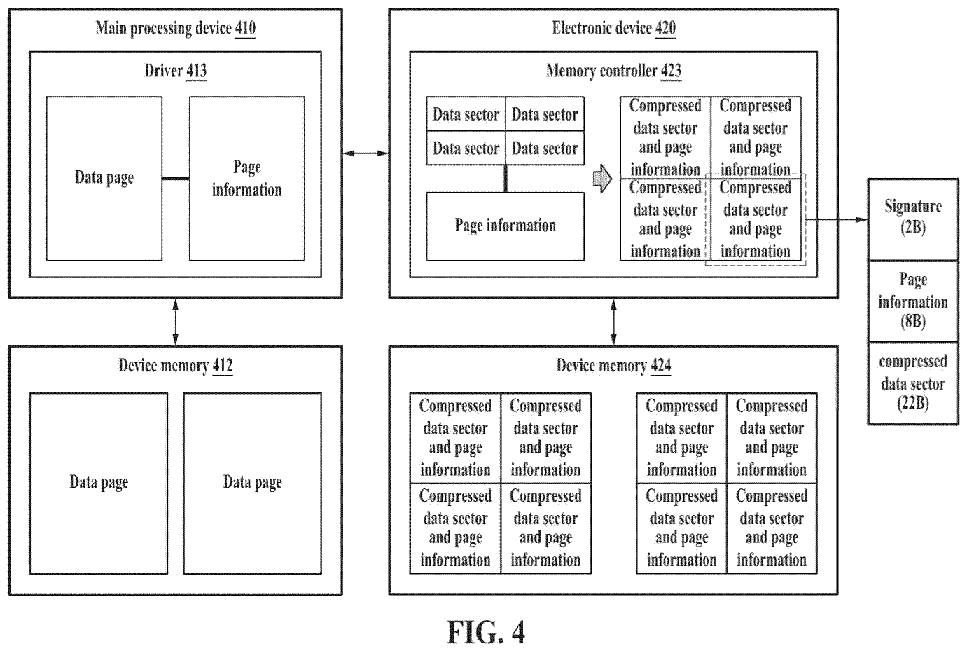

FIG. 4 is a diagram illustrating an example of an operation of storing data in a device memory of an electronic device, according to one or more embodiments.

An electronic device 420 (e.g., the auxiliary processing device 120 of FIG. 1) may receive data (e.g., a data page) from a main processing device 410 (e.g., the main processing device 110 of FIG. 1) and store the received data in a device memory 424 (e.g., the device memory 124 of FIG. 1). For example, the main processing device 410 may transmit, to the electronic device 420, a data page stored in a device memory 412 (e.g., the memory 112 of FIG. 1) of the main processing device 410. When storing the received data, the electronic device 420 may compress the received data and store the compressed data and page information (e.g., permission) together.

The electronic device 420 may include the device memory 424 and a memory controller 423 (e.g., the memory controller 123 of FIG. 1) for the device memory 424. The memory controller 423 may receive, from the main processing device 410, page information including a data page and a VPN of the data page. According to one or more embodiments, the main processing device 410 may use a driver 413 (e.g., the driver 113 of FIG. 1) to determine a memory area in the device memory 424 to store a data page and/or a physical address of the memory area. The main processing device 410 may transmit, using the driver 413, to the electronic device 420, information about the memory area (e.g., a physical address of the memory area), a data page, and page information.

The memory controller 423 may compress the data page received from the main processing device 410. According to one or more embodiments, the memory controller 423 may further include compression circuitry. The compression circuitry of the memory controller 423 may perform data compression. The memory controller 423 may store the compressed data page and page information in a memory area allocated to the data page in the device memory 424. For example, the memory controller 423 may compress a data sector, which is an access unit of a processing unit, in the data page. The memory controller 423 may store the compressed data sector and page information in a memory area allocated to the data sector in the device memory 424.

According to one or more embodiments, the memory controller 423 may obtain a bit sequence including a series of bits based on the data sector. The memory controller 423 may compress a bit sequence. The memory controller 423 may store page information together with the compressed bit sequence (e.g., the compressed data sector) in the memory area allocated to the data sector.

According to one or more embodiments, data sectors separated from the same data page may be compressed and stored together with the same page information. For example, the memory controller 423 may store page information together with a compressed first data sector obtained as a result of compressing a first data sector for the first data sector and a second data sector included in the data page. The memory controller 423 may store the compressed first data sector and the page information in the memory area allocated to the first data sector. The memory controller 423 may store page information together with a compressed second data sector obtained as a result of compressing the second data sector. The memory controller 423 may store the compressed second data sector and the page information in the memory area allocated to the second data sector.

Referring to FIG. 4, the compressed data sector and the page information may include a signature (e.g., 2 bits), page information (e.g., 8 bits), and a compressed data sector (e.g., 22 bits). The signature may include a value indicating whether data stored in a memory area (e.g., a memory area allocated to a data sector) is a compressed data sector and page information or a compression-independent (e.g., non-compressed) data sector.

In one or more embodiments, the memory controller 423 (e.g., the compression circuitry of the memory controller 423) is mainly described as compressing a data sector, but embodiments are not limited thereto. For example, the memory controller 423 may have difficulty compressing a data sector depending on properties (e.g., structure and bit string) of the data sector. Based on determining not to compress the data sector, the memory controller 423 may store only the data sector in the memory area allocated to the data sector and not store page information. As described below with reference to FIG. 5, when a non-compressed data sector is obtained, a speculative physical address may be validated through a valid physical address without performing validation with a validation virtual address.

FIG. 5 is a diagram illustrating an example of an operation of validating a speculative physical address, according to one or more embodiments.

According to one or more embodiments, a processing unit 500 of an electronic device may include a core 510 (e.g., a GPU core) and an L1 cache 520. The core 510 may be a computing unit that executes instructions and/or performs operations. The L1 cache 520 may include an L1 cache memory 521, an MSHR 522, and an L1 cache controller 523.

As described above, the MSHR 522 may store information about a memory access request when an L1 cache miss occurs. The information about a memory access request may include a target virtual address and a speculative physical address. As an example in FIG. 5, the information about a memory access request may include a VPN of the target virtual address, a PPN of the speculative physical address, and sector information. The sector information may include information indicating a data sector corresponding to a page offset among data sectors of a data page corresponding to the VPN of the target virtual address, based on the page offset of the target virtual address.

The processing unit 500 may obtain temporary data stored in a memory area corresponding to the speculative physical address, as described above or similarly with reference to FIGS. 1 to 3.

Based on the obtained temporary data including the validation virtual address (e.g., page information), the processing unit 500 may validate the speculative physical address using the validation virtual address. The temporary data including the verification virtual address may imply that the temporary data is a compressed data sector and page information including a result (e.g., a compressed data sector) of compressing the data sector. For example, the processing unit 500 may determine that validation of the speculative physical address is successful when the target virtual address is the same as the validation virtual address. The processing unit 500 may determine that the validation of the speculative physical address fails to pass when the target virtual address is different from the validation virtual address.

Based on the temporary data not including the validation virtual address, the processing unit 500 may determine that it is impossible to validate the speculative physical address based on the validation virtual address. The temporary data not including the validation virtual address may indicate that the temporary data includes a data sector (e.g., a non-compressed data sector), not a result of compressing the data sector.

For reference, failure to validate the speculative physical address may indicate that the speculative physical address is incorrect, as the speculative physical address is different from an actual physical address (e.g., the validation physical address). On the other hand, the fact that it is impossible to validate the speculative physical address based on the validation physical address may indicate that the actual physical address is not obtained from the temporary data since a data sector is not compressed and may not indicate that the speculative physical address is incorrect.

A memory management unit (e.g., the memory management unit 122 of FIG. 1) may obtain a valid physical address in parallel with acquisition of the speculative physical address. When validation of the speculative physical address through the valid physical address is successful (e.g., when the valid physical address is the same as the speculative physical address), the electronic device may determine that the temporary data is valid data. Furthermore, the electronic device may obtain, as a response to the memory access request, temporary data stored in the memory area corresponding to the speculative physical address.

Referring to FIG. 5, the processing unit 500 may validate the speculative physical address based on the compressed data.

In operation S501, the L1 cache 520 may obtain compressed data stored in the target virtual address and the memory area. The L1 cache 520 may obtain, as compressed data from the L2 cache, a compressed data sector and page information. The L1 cache 520 may obtain at least a portion of the target virtual address from the MSHR 522.

In operation S502, the L1 cache 520 may decompress the compressed data into temporary data and obtain a validation virtual address from the compressed data. In FIG. 5, the temporary data may be illustrated as data. The validation virtual address may include a validation VPN.

In operation S503, the L1 cache 520 may compare, as an in-cache operation, the validation virtual address with the target virtual address.

In operation S504, the L1 cache 520 may store (e.g., write) the temporary data in the L1 cache memory 521 based on the target virtual address being the same as the validation virtual address.

In operation S505, the L1 cache 520 may transmit, to the core 510, the temporary data stored in the L1 cache memory 521 as a response to the memory access request.

The L1 cache 520 may not store the temporary data in the L1 cache memory 521 based on the target virtual address being different from the validation virtual address. When the target virtual address is different from the validation virtual address, the L1 cache 520 may determine that the validation of the speculative physical address fails to pass. The L1 cache 520 may obtain, from the memory management unit, a valid physical address corresponding to the target virtual address. The L1 cache 520 may store data stored in the memory area corresponding to the valid physical address in the L1 cache memory 521. The L1 cache 520 may transmit data stored in the L1 cache memory 521 to the core 510. An operation in which the L1 cache 520 obtains the valid physical address is described in detail with reference to FIG. 6.

As described above with reference to FIG. 4, data stored in the memory area corresponding to the speculative physical address may be non-compressed data. For example, non-compressed temporary data may not include the validation virtual address.

The L1 cache 520 may obtain the valid physical address from the memory management unit based on temporary data not including the validation virtual address.

The L1 cache 520 may validate the speculative physical address using the valid physical address. For example, when the valid physical address is the same as the speculative physical address, the L1 cache 520 may determine that the validation of the speculative physical address is successful. For example, when the valid physical address is different from the speculative physical address, the L1 cache 520 may determine that the validation of the speculative physical address fails to pass.

The L1 cache 520 may obtain data stored in a memory area corresponding to the valid physical address. When the data stored in the memory area corresponding to the valid physical address is compressed data, the L1 cache 520 may decompress the compressed data. However, since it is guaranteed that the valid physical address is valid even without a validation operation, the L1 cache 520 may skip the comparison between the decompressed validation virtual address and the target virtual address. When the data stored in the memory area corresponding to the valid physical address is non-compressed data, the L1 cache 520 may store the data in the L1 cache memory 521.

The L1 cache 520 may transmit the data stored in the L1 cache memory 521 to the core 510 as a response to the memory access request.

FIG. 6 is a diagram illustrating a time difference between a case in which an electronic device uses a speculative physical address and a case in which the electronic device uses a valid physical address, according to one or more embodiments.

According to one or more embodiments, an electronic device (e.g., the auxiliary processing device 120 of FIG. 1) (e.g., a processor) may, in response to a memory access request including a target virtual address, look up the target virtual address in an L1 TLB. The electronic device (e.g., a memory management unit) may use an offset table to determine a speculative physical address when an L1 TLB miss occurs. In FIG. 6, the electronic device may complete determining the speculative physical address at a first timepoint t1.

According to one or more embodiments, the electronic device (e.g., a memory management unit) may obtain the valid physical address corresponding to the virtual address using a page table in parallel with at least one of acquisition or validation of the speculative physical address. In FIG. 6, the electronic device may perform an L2 TLB and page walk in the background from the first timepoint t1. For reference, the memory management unit may include a first hardware module that performs a function of translating a virtual address into a physical address and a second hardware module that performs a function of obtaining data stored in a memory area corresponding to the physical address. During a time interval between the first timepoint t1 and a second timepoint t2, the first hardware module of the memory management unit may perform an operation for obtaining data stored in the memory area corresponding to the speculative physical address in the background and the second hardware module of the memory management unit may perform an operation for obtaining a valid physical address in the foreground.

The electronic device may obtain, from an L2 cache and/or a device memory, temporary data stored in the memory area corresponding to the speculative physical address. The electronic device may transmit temporary data to the L1 cache and/or transmit a page table entry based on the speculative physical address to the L1 TLB. In FIG. 6, the electronic device may complete transmitting the temporary data to the L1 cache of the processing unit at the second timepoint t2.

According to one or more embodiments, the electronic device (e.g., the memory management unit) may stop proceeding with an operation of obtaining the valid physical address based on the validation of the speculative physical address being successful before completing the operation of obtaining the valid physical address.

In a graph 610 of FIG. 6, the L1 cache of the electronic device may determine that the validation of the speculative physical address is successful at the second timepoint t2. The L1 cache may transmit, to the memory management unit, information indicating that the validation of the speculative physical address is successful. In response to the information indicating that the validation of the speculative physical address is successful, the memory management unit may stop acquisition of the valid physical address performed in the background.

According to one or more embodiments, the electronic device (e.g., the memory management unit) may obtain valid data from the memory area corresponding to the valid physical address, based on failure to validate the speculative physical address. The electronic device may transmit, to the processing unit, a response including the valid data.

In a graph 620 of FIG. 6, the L1 cache of the electronic device may determine that the validation of the speculative physical address fails to pass at the second timepoint t2. According to one or more embodiments, the L1 cache may transmit, to the memory management unit, information indicating that the validation of the speculative physical address fails to pass. The memory management unit may continue to perform the acquisition of the valid physical address in the background in response to the information indicating that the validation of the speculative physical address fails to pass. According to one or more embodiments, the L1 cache may not transmit information about the validation of the speculative physical address to the memory management unit. The memory management unit may complete the acquisition of the valid physical address. In the graph 620, at a third timepoint t3, the memory management unit of the electronic device may obtain the valid physical address.

The electronic device may obtain valid data from the memory area corresponding to the valid physical address. The electronic device may sequentially look up the L1 TLB and/or the L1 cache, the L2 TLB and/or the L2 cache, and the device memory and may load valid data into the L1 TLB and/or the L1 cache. In the graph 620, at a fourth timepoint t4, the processing unit of the electronic device may obtain data stored in the memory area corresponding to the valid physical address as a response to the memory access request.

According to one or more embodiments, when the speculative physical address is valid, the electronic device may transmit valid data as a response based on temporary data obtained for the validation of the speculative physical address and may thus obtain a response in less time (e.g., in less time as short as the second timepoint t2 to the fourth timepoint t4) than a device that does not use the speculative physical address. In addition, since the operation in which the memory management unit obtains the valid physical address is performed in parallel with the acquisition of the speculative physical address and/or the validation of the speculative physical address, even when the speculative physical address is invalid, the electronic device may obtain valid data in the same or similar time (e.g., the first timepoint t1 to the fourth timepoint t4) as a device that obtains the valid physical address without using the speculative physical address.

According to one or more embodiments, when the electronic device determines that the speculative physical address is invalid data (e.g., when determining that the verification of the speculative physical address fails to pass) after starting an operation of the processing unit based on the invalid data, it may be difficult or impossible to roll back the operation already performed. After obtaining temporary data based on the speculative physical address, the electronic device may wait for an execution based on the temporary data until the validation of the temporary data (e.g., the validation of the speculative physical address) is successful. However, as described with reference to FIG. 6, the electronic device may immediately determine that the temporary data is valid by validating the temporary data based on a portion of the temporary data, and the processing unit may operate based on the valid data.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An electronic device comprising:
a processing unit;
a memory management unit; and
a memory,
wherein the memory management unit is configured to, based on a memory access request for accessing a target virtual address received from the processing unit, translate the target virtual address into a speculative physical address based on an offset table comprising an address translation offset per program counter, and
wherein the processing unit is configured to:
obtain temporary data stored in a first memory area that corresponds to the speculative physical address, wherein the first memory area is in the memory;
validate the speculative physical address by comparing the target virtual address with a validation virtual address included in the temporary data stored in the first memory area that corresponds to the speculative physical address; and
based on a successful validation of the speculative physical address, determine that the temporary data is valid data.

2. The electronic device of claim 1, wherein the processing unit further comprises a level 1 (L1 ) cache, and
wherein the L1 cache is configured to:
obtain the target virtual address and compressed data stored in the first memory area;
decompress the compressed data into the temporary data;
obtain the validation virtual address from the compressed data; and
compare, as an in-cache operation, the validation virtual address to the target virtual address.

3. The electronic device of claim 1, wherein the memory management unit comprises a level 1 (L1) translation lookaside buffer (TLB) (L1 TLB), and
wherein the L1 TLB is configured to:
obtain the memory access request prior to the memory management unit translating the target virtual address into the speculative physical address;
based on the memory access request, look up, in an internal memory of the L1 TLB, a page table entry corresponding to the target virtual address;
based on the internal memory of the L1 TLB including the page table entry corresponding to the target virtual address, obtain a valid physical address based on the page table entry; and
based on the internal memory of the L1 TLB not including the page table entry corresponding to the target virtual address, transmit, to the memory management unit, a request for obtaining the speculative physical address using the offset table.

4. The electronic device of claim 1, wherein the memory management unit is further configured to:
determine, from among candidate address translation offsets included in the offset table, a target address translation offset corresponding to a target program counter of the memory access request; and
obtain the speculative physical address based on a result of applying the target address translation offset to the target virtual address.

5. The electronic device of claim 4, wherein the memory management unit is further configured to:
determine, from among candidate offset table entries included in the offset table, an offset table entry corresponding to the target program counter;
based on a confidence level (CL) identifier indicating a CL for the target address translation offset in the determined offset table entry, determine whether to use the target address translation offset; and
based on determining to use the target address translation offset, obtain the speculative physical address using the target address translation offset.

6. The electronic device of claim 1, wherein the memory management unit is further configured to obtain a valid physical address corresponding to the target virtual address using a page table in parallel with at least one of an acquisition process of the speculative physical address and a validation process of the speculative physical address.

7. The electronic device of claim 6, wherein the processing unit is further configured to:
based on failure to validate the speculative physical address, obtain valid data from a second memory area corresponding to the valid physical address.

8. The electronic device of claim 6, wherein the memory management unit is further configured to, based on the successful validation of the speculative physical address, determine to not proceed with an operation of obtaining the valid physical address or determine to stop proceeding with the operation of obtaining the valid physical address if the operation of obtaining the valid physical address is proceeding when the speculative physical address is successfully validated.

9. The electronic device of claim 1, wherein the processing unit is further configured to:
based on the temporary data including the validation virtual address, validate the speculative physical address using the validation virtual address; and
based on the temporary data not including the validation virtual address, determine that it is not possible to validate the speculative physical address based on the validation virtual address.

10. The electronic device of claim 1, wherein the memory comprises a device memory,
wherein the electronic device further comprises a memory controller configured to operate with the device memory, and
wherein the memory controller is configured to:
receive, from a main processing device, page information comprising a data page and a virtual page number (VPN) of the data page;
compress the data page; and
store the compressed data page and the page information in a third memory area of the device memory that is allocated to the data page.

11. The electronic device of claim 10, wherein the data page comprises a data sector corresponding to an access unit of the processing unit, and
wherein the memory controller is further configured to store the compressed data sector and the page information in a fourth memory area in the device memory allocated to the data sector.

12. The electronic device of claim 11, wherein the data page comprises a first data sector and a second data sector, and
wherein the memory controller is further configured to:
store, together with the page information, a compressed first data sector obtained by compressing the first data sector; and
store, together with the page information, a compressed second data sector obtained by compressing the second data sector.

13. The electronic device of claim 1, wherein the memory management unit is further configured to, based on the successful validation of the speculative physical address, increase a confidence level (CL) of an offset table entry corresponding to a target program counter of the memory access request in the offset table.

14. The electronic device of claim 1, wherein the memory management unit is further configured to, based on failure to validate the speculative physical address, change an offset table entry corresponding to a target program counter of the memory access request in the offset table, based on an offset between the target virtual address and a valid physical address.

15. The electronic device of claim 1, wherein the memory management unit comprises a level 1 (L1) translation lookaside buffer (TLB) (L1 TLB), and
wherein the L1 TLB is configured to, based on the successful validation of the speculative physical address, store a page table entry comprising the speculative physical address and the target virtual address in an internal memory of the L1 TLB.

16. A method performed by an electronic device that comprises a processing unit, a memory management unit, and a memory, the method comprising:
translating, by the memory management unit and based on a memory access request for a target virtual address received from the processing unit, the target virtual address into a speculative physical address based on an offset table comprising an address translation offset per program counter;
obtaining, by the processing unit, temporary data stored in a first memory area that corresponds to the speculative physical address wherein the first memory area is in the memory;
validating, by the processing unit, the speculative physical address by comparing the target virtual address with a validation virtual address included in the temporary data stored in the first memory area that corresponds to the speculative physical address; and
based on a successful validation of the speculative physical address, determine that the temporary data is valid data.

17. The method of claim 16, wherein the processing unit further comprises a level 1 (L1) cache, and
wherein the validating of the speculative physical address comprises:
obtaining, by the L1 cache, compressed data stored in the target virtual address and the first memory area;
decompressing, by the L1 cache, the compressed data into the temporary data;
obtaining the validation virtual address from the compressed data; and
comparing, by the L1 cache, as an in-cache operation, the validation virtual address with the target virtual address.

18. The method of claim 16, wherein the memory management unit comprises a level 1 (L1) translation lookaside buffer (TLB) (L1 TLB), and
wherein the method further comprises:
obtaining, by the L1 TLB, the memory access request prior to the memory management unit translating the target virtual address into the speculative physical address;
looking up, by the L1 TLB, based on the memory access request, a page table entry corresponding to the target virtual address in an internal memory of the L1 TLB;
obtaining, by the L1 TLB, based on the internal memory of the L1 TLB including the page table entry corresponding to the target virtual address, a valid physical address based on the page table entry; and
based on the internal memory of the L1 TLB not including the page table entry corresponding to the target virtual address, transmitting, by the L1 TLB, to the memory management unit, a request for obtaining the speculative physical address using the offset table.

19. The method of claim 16, wherein the translating of the target virtual address into the speculative physical address comprises:
determining, by the memory management unit, from among candidate address translation offsets included in the offset table, a target address translation offset corresponding to a target program counter of the memory access request; and
obtaining, by the memory management unit, the speculative physical address based on a result of applying the target address translation offset to the target virtual address.

20. The method of claim 19, wherein the translating of the target virtual address into the speculative physical address further comprises:
determining, by the memory management unit, from among candidate offset table entries included in the offset table, an offset table entry corresponding to the target program counter;
based on a confidence level (CL) indicator indicating a CL for the target address translation offset of the determined offset table entry, determining, by the memory management unit, whether to use the target address translation offset; and
based on determining to use the target address translation offset, obtaining, by the memory management unit, the speculative physical address based on the target address translation offset.
